(19) United States
(12) Patent Application Publication
(10) Pub. No.: US 2006/0271252 A1
(43) Pub. Date: Nov. 30, 2006

(54) Transportation system

(75) Inventors: Kikuo Hori, Kyoto-shi (JP); Kazuro Ueshima, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/431,512

(22) Filed: May 11, 2006

(30) Foreign Application Priority Data
May 26, 2005 (JP) 2005-153406

(51) Int. Cl. G01C 22/00

(52) U.S. Cl. 701/23; 180/169

(57) ABSTRACT

A guided vehicle controller 20 transmits the standard time to a guided vehicle 14. The guided vehicle 14 reports a coordinate representing the current position and the transmission time to the controller 20. The controller 20 generates time series data obtained by combining the transmission time and the coordinate. Based on the time series data, the current coordinate of the guided vehicle is estimated. By converting current coordinates of a plurality of guided vehicles into the distribution of guided vehicles, instructions about the travel routes are provided to the guided vehicles for congestion avoidance. Further, a suitable guided vehicle capable of efficiently executing a transportation command is selected, and the transportation command is assigned to the selected guided vehicle.

### TECHNICAL FIELD

The present invention relates to a transportation system such as an overhead traveling vehicle system, a rail vehicle system for traveling on the ground, an automated guided vehicle system, an automated warehouse system including a plurality of stacker cranes, or a conveyor system. In particular, the present invention relates to distribution of guided vehicles or transportation articles.

### BACKGROUND ART

In a system including a plurality of guided vehicles, the guided vehicles report their current positions to a controller, respectively, and based on the reported information, the controller carries out assignment of transportation commands or the like (Japanese Patent No. 3,189,883). Further, a travel route for the guide vehicle is divided into a plurality of nodes. The controller provides permission to the guided vehicle in the unit of nodes, and the guided vehicle reports the current position in the unit of nodes.

However, the guided vehicles do not report the current positions at the same time. If a large number of guided vehicles report their current positions at the same time, for example, the communication traffic may exceed the communication capacity of the LAN. Further, the report of the current position of the guided vehicle does not always arrive at the controller at one time. For example, if any failure occurs in the middle of communication, the guided vehicle transmits the current position again. In this case, the transmission interface of the guided vehicle carries out retransmission because the receipt of the report of the current position cannot be confirmed. Therefore, the current position at the time of the retransmission is same as the current position when the failure occurred at the time of the previous transmission.

Other than the above system, in a conveyor system, transportation of articles by the guided vehicles as described above is carried out using conveyors. In the system, a transportation route is formed by a plurality of conveyors that can be turned on or off independently. In an area where congestion of articles occurs, by stopping the conveyor until the congestion is eliminated, the following article is prevented from pushing strongly against the leading article. The stopping operation or restarting operation of the conveyor causes a time loss, and applies a mechanical load to the conveyor. As a result, the lifetime of the conveyor is reduced.

### SUMMARY OF THE INVENTION

An object of the present invention is to make it possible to keep track of the current status of a plurality of transportation apparatuses even if the status of the transportation apparatuses are reported at different timings, or even in the presence of the communication delay due to retransmission or the like.

Secondary object of the present invention is to allow a system including a plurality of guided vehicles to accurately evaluate distribution of the guided vehicles.

Secondary object of the present invention is to achieve efficient transportation by avoiding congestion of guided vehicles.

The present invention relates to a transportation system including a plurality of transportation apparatuses and a controller for management of the apparatuses. Each of the transportation apparatuses comprises means for reporting the status of the apparatus together with the time to the controller. The controller comprises: estimation means for estimating at least current status of the each transportation apparatus based on the reported status of the each apparatus together with the time; and status evaluation means for determining status of the system based on the estimation.

Preferably, each of the transportation apparatuses is a guided vehicle, and the guided vehicle reports a coordinate along a travel route as the status of the each apparatus, the guided vehicle.

In particular, preferably, the status evaluation means determines distribution of the guided vehicles on the travel route, and the controller or the guided vehicle searches a travel route based on the determined distribution for collision avoidance.

Preferably, a plurality of beacons are provided along the travel route, and each of the guided vehicles comprises an encoder for determining the traveling distance, means for reading the beacon, and means for determining the coordinate along the travel route based on the traveling distance determined by the encoder after reading the beacon, and the read beacon. For example, the coordinate is a value obtained by adding the coordinate of the beacon and the traveling distance, or the coordinate comprises two components, i.e., an ID of the read beacon and the traveling distance from the beacon.

More preferably, the estimation means estimates a current coordinate of the each guided vehicle, based on time series data of the coordinate along the travel route of each guided vehicle together with the time at the coordinate.

Most preferably, when each guided vehicle passes a branch in the travel route, the guided vehicle reports the direction of passing the branch to the controller together with the coordinate along the travel route. For example, assuming that the coordinate is so called a one-dimensional coordinate calculated by adding the coordinate of the beacon and the traveling distance from the beacon, a branching direction is added to the one-dimensional coordinate to generate a two-dimensional coordinate, and the two-dimensional coordinate is reported to the controller.

In the present invention, the status of the transportation apparatus and the time are inputted to the controller for at least estimating the current status. Even if the reports from the transportation apparatuses are transmitted at different timings, since the reporting time of each of the transportation apparatuses is known, the current status can be estimated by correcting the reported status based on the elapsed time up to the current time. Further, even if retransmission of the report is carried out due to the communication failure, it is also possible to estimate the current status.

In the case where the guided vehicles report their coordinates along travel routes to the controller, it is possible to determine the positions of the guided vehicles, and assign the transportation commands without any congestion efficiently.

In the case where the status evaluation means determines the distribution of guided vehicles on the travel routes, the controller or the guided vehicle can search its travel route based on the determined distribution for congestion avoidance.

In the case where each guided vehicle reads the beacon provided along the travel route, and the traveling distance from the beacon is determined by the encoder, the guided vehicle can determine the coordinate along the travel route easily.

In the case where the estimation means of the controller estimates the current coordinate of each guided vehicle based on the time series data of the coordinate of the guided vehicle along the travel route and the time, the current time can be estimated accurately.

If the travel route includes a branch point, the current position cannot be identified only based on the traveling distance from the beacon. However, if the direction of passing the branch point is reported to the controller together with the data of the traveling distance from the beacon, the coordinate of the guided vehicle can be identified.

### BRIEF DESCRIPTION OF THE DRAWINGS

FIG. 1 is a plan view schematically showing the layout of main components of a guided vehicle system according to an embodiment.

FIG. 2 is a block diagram showing structure of a guided vehicle controller according to the embodiment and the content of communication with a guided vehicle.

FIG. 3 is a block diagram showing communication between the guided vehicle controller and the guided vehicle according to the embodiment, and processes carried out by the guided vehicle controller.

Brief Description of the Symbols

| | |
|---|---|
| 2 | Guided vehicle system |
| 4 | Inter-bay route |
| 6 | Bypass route |
| 8, 9 | Shortcut |
| 10, 11 | Intra-bay route |
| 12 | Beacon |
| 14-17 | Guided vehicle |
| 18 | Destination |
| 20 | Guided vehicle controller |
| 22 | LAN |
| 24 | Clock |
| 26 | Reception interface |
| 28 | Time series data memory unit |
| 30 | Layout map |
| 32 | Estimation engine for estimating current coordinate |
| 34 | Distribution information memory unit |
| 36 | Travel management unit |
| 38 | Transportation command assignment unit |

### EMBODIMENT

Hereinafter, an embodiment in the most preferred form for carrying out the present invention will be described.

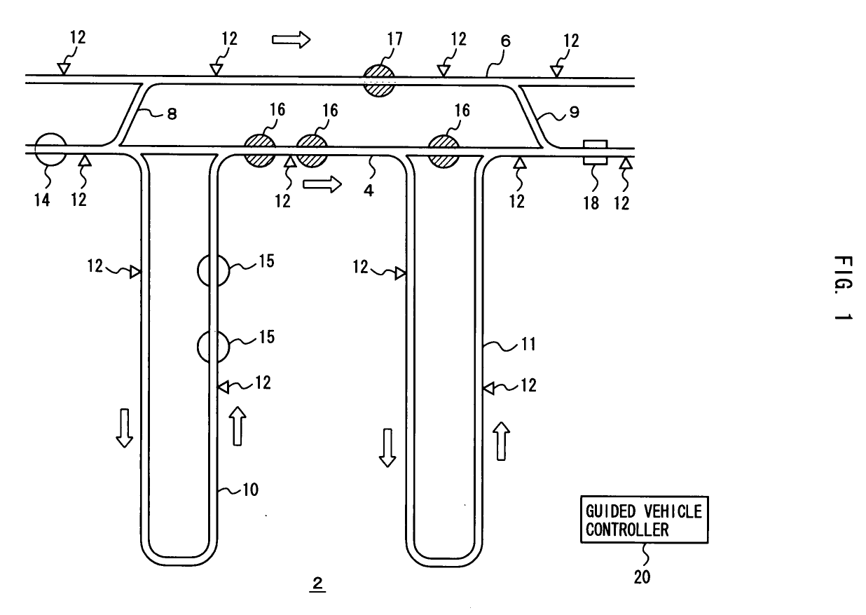

FIGS. 1 to 3 show a guided vehicle system according to the embodiment. In the embodiment, it is assumed that the guided vehicles are overhead traveling vehicles. A reference numeral 2 denotes the guided vehicle system. For example, the guided vehicle system 2 is provided in a clean room or the like. A reference numeral 4 denotes an inter-bay route, a reference numeral 6 denotes a bypass route, and reference numerals 8 and 9 denote shortcuts connecting the inter-bay route 4 and the bypass route 6. Intra-bay routes 10, 11 are connected to the inter-bay route 4. Beacons 12 are provided along the routes 4,6,10, and 11. Each of the guided vehicles 14 to 17 has a reader for reading the beacon 12 to recognize the current position. For example, the beacon 12 is a barcode or an RFID. The ID of the beacon itself is written in the barcode or the RFID such that the guided vehicles 14 to 17 can determine the coordinate based on the ID with reference to a map of the travel route. Otherwise, the coordinate on the travel route is written in the beacon 12 itself. The guided vehicles 14 to 17 travel in one-way direction indicated by arrows in FIG. 1. Further, the guided vehicles 14 to 17 may be equipped with a position recognition device for determining the distance from a mark or measuring the orientation by a laser so that the absolute position on the travel route can be determined directly.

At this time, it is assumed that the guided vehicle 14 travels from the current position in FIG. 1 to a destination 18. There are two travel routes for the guided vehicles 14. One of the travel routes extends straight along the inter-bay route 4, and the other of the travel routes utilizes the shortcuts 8,9, and goes through the bypass route 6. Leading guided vehicles 16 are present in the inter-bay route 4, and a leading guided vehicle 17 is present in the bypass route 6. In the embodiment, the number of the leading guided vehicles 16 is large in comparison with the leading guided vehicle 17. A reference numeral 20 denotes a guided vehicle controller for assigning transportation commands, and providing instructions about the travel routes to the guided vehicles 14 to 17. Further, the guided vehicle controller 20 permits the guided vehicles 14 to 17 to travel through the shortcuts 8, 9, and controls traveling in merging sections or branch sections between the inter-bay route 4 and the intra-bay routes 10, 11. In terms of control, the shortcuts 8, 9 are regarded as combination of the branch section and the merging section.

When the guided vehicles 14 to 17 autonomously control traveling in the branch sections and the merging sections, the guided vehicle controller 20 does not have to implement the control for the branch sections and the merging sections. In the embodiment, the guided vehicle controller 20 provides instructions about the travel routes to the guided vehicles 14 to 17. Alternatively, the guided vehicles 14 to 17 may make inquiries to the guided vehicle controller 20 about the congestion status in the travel route, i.e., the number of guided vehicles present in each zone of the travel route, or distribution of guided vehicles in the travel route so as to autonomously determine the travel route, and avoid congestion.

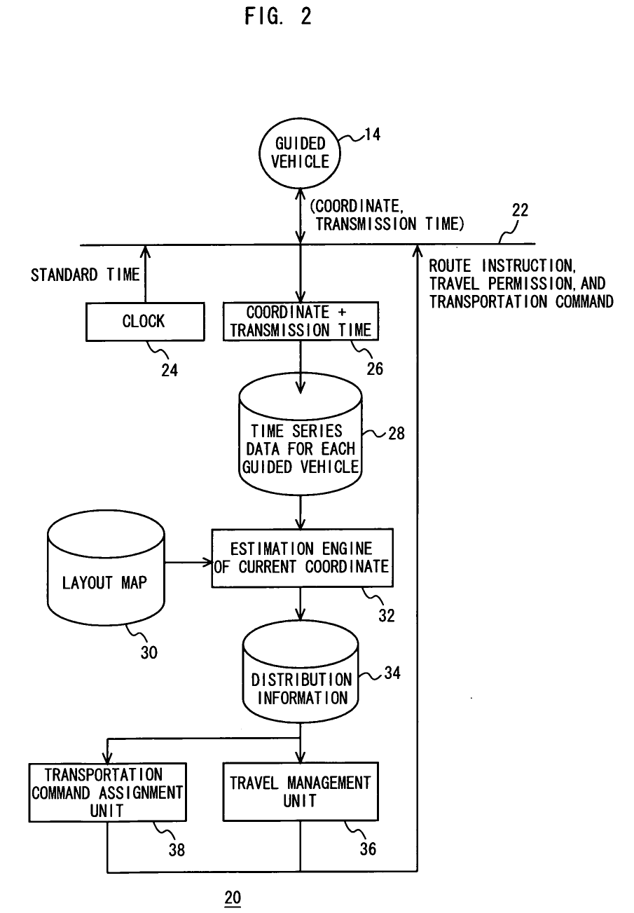

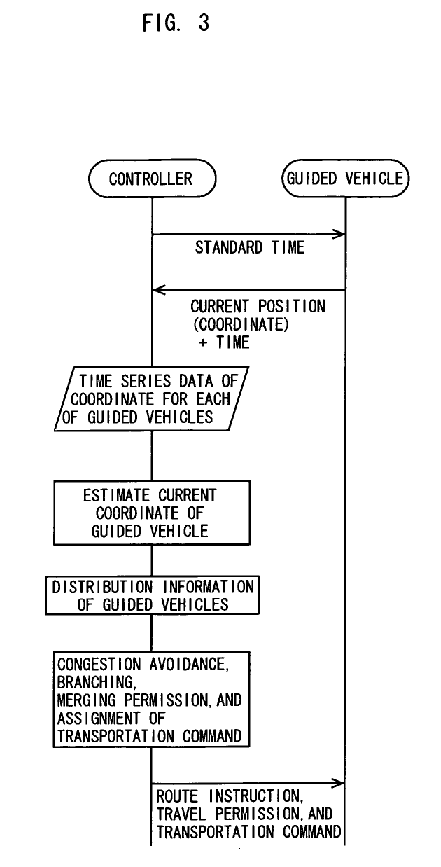

FIGS. 2 and 3 show communication between the guided vehicle 14 or the like and the guided vehicle controller 20, and structure of the guided vehicle controller 20. As an example, the process of communication with the guided vehicle 14 is illustrated. The process of communication with the other guided vehicles can be carried out in the same manner. A reference numeral 22 denotes a LAN of the guided vehicle system. The guided vehicle 14 communicates with the guided vehicle controller 20 through the LAN 22. Further, communication between guided vehicles can be carried out through the LAN 22. The time of a clock 24 of the guided vehicle controller 20 is regarded as the standard time, and the time is notified to the LAN 22, e.g., at predetermined time intervals. The guided vehicle 14 receives the time for synchronizing the time of the guided vehicle 14 to the time of the guided vehicle controller 20.

For example, the guided vehicle 14 sends the coordinate of the current position and the time when the transmission is done to the LAN 22 at predetermine time intervals, and the guided vehicle controller 20 receives these items of data through a reception interface 26. The coordinate is positioned along the travel route in FIG. 1. For example, the coordinate is calculated by adding the coordinate of the last passed beacon and the traveling distance from the beacon determined by the encoder. If there is any branch section, it is not possible to determine the coordinate of the guided vehicle 14 only by the traveling distance from the beacon. Therefore, by adding data of the branching direction, such as branching to the left, straight forward, or branching to the right, the coordinate on the travel route is identified. The time used herein is the transmission time or the time of determining the coordinate, and the change of the coordinate between the transmission time and the time of determining the coordinate is, e.g., 1 cm or less.

The reception interface 26 inputs the received coordinate and the transmission time to a time series data memory unit 28. Other than the time and the coordinate, status information such as occupied/vacant, or the destination designated by a transportation command may be added to the time series data. The time series data memory unit 28 independently stores each of the time series data, including the coordinate and the transmission time, of the each guided vehicle. The time series data is inputted to an estimation engine 32 for estimating the current coordinate. The engine 32 refers to a layout map 30 showing travel routes for estimating the current coordinate by extrapolation of the time series data. For example, using the speed between the recent two points and the period from the last transmission time to the current time, the current coordinate is estimated. Since the guided vehicle travels in one direction, when the guided vehicle is not in the branch section, the current coordinate can be determined from the layout map 30. Since permission to travel in the branch section is given from the guided vehicle controller 20 to the guided vehicle 14 or the like, the branching direction is known to the guided vehicle controller 20.

The current coordinate estimation engine 32 inputs the determined current coordinate to a distribution information memory unit 34. The distribution information memory unit 34 stores distribution information about the distribution of the current positions of guided vehicles. The accuracy of positions used in the distribution information may be lower than the accuracy of the coordinate determined by the estimation engine 32. The distribution information is constantly updated by the estimation engine 32. Based on the distribution information, a travel management unit 36 provides instructions about the travel route to the guided vehicle 14 for avoiding congestion. For example, in the case of FIG. 1, in the inter-bay route 4, three leading guided vehicles 16 are present between the current position of the guided vehicle 14 and the destination 18, and in the bypass route 6, one leading guided vehicle 17 is present between the current position of the guided vehicle 14 and the destination 18. Therefore, the guided vehicle 14 is instructed to travel into the bypass route 6 through the shortcuts 8 and 9. In this manner, the guided vehicles can travel without congestion. The instructions about the travel route may not be provided from the guided vehicle controller 20. Alternatively, the distribution information may be transmitted from the guided vehicle controller 20 to the guided vehicle 14 or the like such that the guided vehicle 14 can determine the travel route. The congestion avoidance algorithm is used when distribution of guided vehicles is determined, and the congestion avoidance algorithm itself is known.

In the branch section or the merging section, it is difficult to avoid interference between guided vehicles by autonomous control. Therefore, the guided vehicle controller 20 is used for providing permission to travel into the branch section or the merging section. The travel management unit 36 determines positions of other guided vehicles near the branch section or the merging section based on the information provided by the distribution information memory unit 34, and provides permission to travel into the branch section or the merging section. If the distribution of the guided vehicle 14 or the like along the travel route is determined, at the time of assigning a transportation command, it becomes easier to select the most efficient guided vehicle, and assign the transportation command to the selected guided vehicle. A transportation command assignment unit 38 refers to the distribution information stored in the distribution information memory unit 34, and assigns the transportation command to the guided vehicle.

In the conventional technique, each of the guided vehicles reports the current position to the guided vehicle controller 20 by dividing the travel route into a plurality of separate nodes. Basically, these nodes are used for the control in the branch section or the merging section. Since the length of the node is substantially equal to the length of the vehicle body, the accuracy of the current position reported by the guided vehicle is low. In contrast, in the embodiment, the coordinate on the travel route is reported, and the coordinate is based on the beacon 12. Therefore, the accuracy of the current position reported by the guided vehicle is high. Further, communication failures may occur between the guided vehicle and the guided vehicle controller through the LAN 22. In the conventional technique, after the guided vehicle reports the current position, if no confirmation is received from the controller, it is determined that there was a failure in reporting the current position, and the guided vehicle reports the current position again. In this case, since the current position is transmitted again due to the communication failure, the current position is not newly determined again. Thus, the current position that has already been determined is reported. Therefore, the current position received by the controller has the error corresponding to the delay of transmission.

In contrast, in the embodiment, the guided vehicle transmits the coordinate and the time. If communication fails, data of the beacon and the time is not rewritten, and transmitted again. However, the controller can obtain the information as to what time, and at which coordinate the guided vehicle was present. Basically, the obtained coordinates are coordinates in the past, at different points of time. Therefore, by extrapolation of the time series data obtained by combination of the coordinate and the time for each of the guided vehicles, the estimation engine can detect the coordinate at present, and the coordinate in the near future, e.g., in the period until the guided vehicle finishes the currently executing transportation command.

After the positions of the guided vehicles are estimated, it is possible to determine the distribution of guided vehicles on the travel route at present, and in the near future. After the distribution of guided vehicles is determined, for example, it becomes proven which route should be selected for efficiently avoiding congestion. If the positions of the guided vehicles near the branch section or the merging section have been found, it is possible to permit traveling into the branch section or the merging section so that the guided vehicle can travel in the branch section or the merging section while avoiding interference between the guided vehicles without causing any deadlock efficiently. Further, if the controller stores the data as to whether the respective guided vehicles are vacant or occupied, in consideration of such data together with the distribution data of the guided vehicles, assignment of the transportation command can be made efficiently.

While the present invention has been described in connection with the example of the guided vehicle system, it should be understood that the present invention is also applicable to conveyor systems.

1. A transportation system including a plurality of transportation apparatuses and a controller for management of the apparatuses, wherein
each of the transportation apparatuses comprises means for reporting status of the each apparatus together with time to the controller, and wherein
the controller comprises: estimation means for estimating at least current status of the each transportation apparatus based on the reported status of the each apparatus together with the time; and status evaluation means for determining status of the system based on the estimation.

2. The transportation system of claim 1, wherein the each transportation apparatus is a guided vehicle, the guided vehicle reports a coordinate along a travel route as the status of the each apparatus, the guided vehicle.

3. The transportation system of claim 2, wherein the status evaluation means determines distribution of the guided vehicles on the travel route, and at least one of the controller and the guided vehicle searches a travel route based on the determined distribution for collision avoidance.

4. The transportation system of claim 2, wherein a plurality of beacons are provided along the travel route, and each of the guided vehicles comprises:
an encoder for determining a traveling distance;
means for reading the beacon; and
means for determining the coordinate along the travel route with the read beacon and the traveling distance determined by the encoder after reading the beacon.

5. The transportation system of claim 4, wherein the estimation means estimates a current coordinate of the each guided vehicle, based on time series data of the coordinate along the travel route of the each guided vehicle together with the time.

6. The transportation system of claim 4, wherein when each guided vehicle passes a branch in the travel route, the each guided vehicle reports a direction of passing the branch to the controller together with the coordinate along the travel route.
